(19) United States
(12) Patent Application Publication
(10) Pub. No.: US 2023/0419291 A1
(43) Pub. Date: Dec. 28, 2023

(54) AUTOMATED PAYMENT SPLITTING

(71) Applicant: Capital One Services, LLC, McLean, VA (US)

(72) Inventors: Phoebe Atkins, Midlothian, VA (US); Xiaoguang Zhu, New York, NY (US); Ray Cheng, Long Island City, NY (US)

(21) Appl. No.: 17/846,540

(22) Filed: Jun. 22, 2022

(51) Int. Cl. G06Q 20/22; G06Q 20/14; G06Q 50/00; G06Q 20/32; G06V 20/30; G06V 40/10

(52) U.S. Cl. CPC G06Q 20/22; G06Q 20/14; G06Q 50/01; G06Q 20/326; G06V 20/30; G06V 40/10; G06V 2201/10

(57) ABSTRACT

Disclosed embodiments pertain to automated payment splitting. A bill to a user for goods or services can be detected. Contacts that are collocated with the user can be determined via social media image analysis. A notification can be sent to the contacts to join a payment group. The payment group can be created upon receiving a response to the notification. A split payment rubric can be determined for the payment group. The split payment rubric can enumerate payment responsibilities of each person in the payment group using social media image analysis. Payment of the bill can be completed via a split payment amongst the payment group according to the split payment rubric.

### BACKGROUND

Sharing bills or checks between customers or friends can be an arduous task. Often, sharing becomes an awkward task to manually determine which customers pay the bill and how much each owes. Splitting a check becomes even more complicated when the customers each provide a conventional payment form such as a credit card. There is increased time and effort for a bill collector to calculate and enter what each person owes and ensure each person is charged the correct amount to their payment form.

### BRIEF SUMMARY OF THE DESCRIPTION

The following presents a simplified summary to provide a basic understanding of some aspects of the disclosed subject matter. This summary is not an extensive overview. It is not intended to identify necessary elements or delineate the scope of the claimed subject matter. Rather, this summary presents some concepts in a simplified form as a prelude to the more detailed description presented later.

According to one aspect, embodiments can include a system comprising a processor coupled to a memory that includes instructions that, when executed by the processor, cause the processor to determine a potential transaction to be completed by a user, identify a subset of contacts that are collocated with the user, automatically send a notification to the user and the subset of contacts to join a payment group, create the payment group based on receiving a response from at least one contact of the subset of contacts and the user, analyze social media image data of the user or the at least one contact, and identify a payment responsibility based on a result of analysis of the social media image data. Further, identification of the payment responsibility includes identify items that appear in the social media image data based on the result of the analysis of the social media image data, match the items that are identified in the social media image data to items of an itemized bill of the potential transaction, and associate items that are matched to a person in the payment group based on the social media image data and the match. Further, a split rubric can be determined for the payment group that provides the payment responsibility for each person of the payment group, and the potential transaction can be completed with two or more payments from the payment group according to the split payment rubric. In one instance, determine the subset of contacts includes instructions that cause the processor to analyze social media image data of contacts to determine contacts that are collocated with the user. The instructions further cause the processor to apply a computer vision technique to the social media image data to identify the user and one or more contacts in the social media image data to determine the user and the one or more contacts are currently collocated. Further, the instructions can cause the processor to extract metadata associated with the social media image data to identify one or more contacts that are collocated with the user. In one scenario, the notification can include a link that adds a contact in the subset of contacts to the payment group when opened. The subset of contacts can also be determined from a set of contacts of the user that is associated with a user device. Additionally, determine the split payment rubric can comprise instructions that cause the processor to analyze social media metadata to determine payment responsibility of each person in the payment group. Instructions can also cause the processor to confirm the match of the items to the itemized bill of the potential transaction to the person in the payment group based on analysis of the social media metadata. Furthermore, determine the split payment rubric can comprise instructions that cause the processor to determine payment responsibility of each person in the payment group by way of tendencies learned about each person in the payment group.

Embodiments can also include a method that comprises executing, on a processor, instructions that cause the processor to perform operations associated with bill splitting. The operations include determining a potential transaction to be completed by a user, analyzing social media image data of the user to determine a subset of contacts that are collocated with the user, automatically sending a request to the user and the subset of contacts to join a payment group, creating the payment group based on receiving a response to the request from at least one contact, wherein the payment group includes the at least one contact and the user, and completing the potential transaction with two or more payments from the payment group. The operations can further comprise determining the subset of contacts from a set of contacts of the user that is associated with a user device or applying a computer vision technique to the social media image data to identify the user and one or more contacts in the social media image data to determine the user and the one or more contacts are currently collocated. The operations can further comprise determining metadata associated with the social media image data to identify one or more contacts that are collocated with the user. Sending the request can further comprise providing a link that adds a contact in the subset of contacts to the payment group when activated in one instance. Further, the operations can comprise predicting a split payment rubric for the payment group, wherein the split payment rubric provides a payment responsibility for each person of the payment group.

According to another aspect, embodiments can pertain to a computer-implemented method, comprising determining a user and a bill and a subset of contacts that are collocated with the user. The subset of contacts can be determined from a set of contacts of the user by analyzing image data of a set of contacts to determine contacts that are collocated with the user, sending a notification to join a payment group to the subset of contacts, and receiving a response from at least one contact of the subset of contacts. The method can further comprise creating the payment group based on receiving the response from the at least one contact of the subset of contacts, determining a split payment rubric for the payment group by analyzing the image data or consumption tendencies of each person in the payment group to determine a payment responsibility of each person in the payment group, and completing a payment of the bill via a split payment amongst the payment group according to the split payment rubric. Completing the payment can also comprise generating a one-time virtual card number to complete the payment of the bill, funding the one-time virtual card number with a split payment amongst the payment group, and completing payment of the bill via the one-time virtual card number.

Disclosed embodiments provide substantial benefits in terms of automated payment splitting. One advantage resides in an automated determination of a payment group and payment responsibilities. Another advantage resides in a streamlined split payment process.

To accomplish the foregoing and related ends, certain illustrative aspects of the claimed subject matter are described herein in connection with the following description and the annexed drawings. These aspects indicate various ways in which the subject matter can be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same can be arbitrarily increased or reduced for clarity of discussion, for example.

FIG. 1 illustrates a high-level diagram of an example implementation.

FIG. 2 illustrates an example component diagram of a bill processing engine.

FIG. 3 illustrates an example component diagram of a group component.

FIG. 4 illustrates an example component diagram of a transaction component.

FIG. 5 illustrates a method for automated payment splitting.

FIG. 6 illustrates a computing environment where one or more of the provisions set forth herein can be implemented, according to some embodiments.

### DETAILED DESCRIPTION

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

As used in this application, the terms “component”, “module,” “system”, “interface”, and the like are generally intended to refer to a computer-related entity, either hardware, a combination of hardware and software, software, or software in execution. For example, a component can be, but is not limited to being, a process running on a processor, a processor, an object, an executable, a thread of execution, a program, or a computer. By way of illustration, both an application running on a controller and the controller can be a component. One or more components residing within a process or thread of execution, and a component can be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications can be made to this configuration without departing from the scope or spirit of the claimed subject matter.

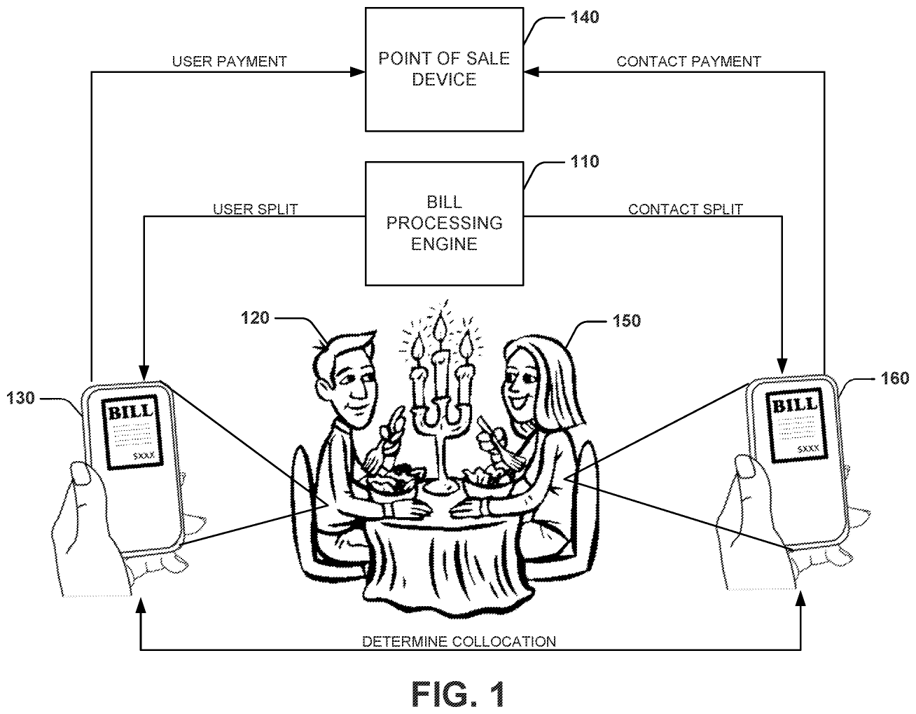

FIG. 1 illustrates a high-level view of an example implementation of aspects of the disclosure. A bill processing engine 110 can determine whether a potential transaction is to be completed by a user 120. For example, the user 120 is at a restaurant having a meal. The bill processing engine 110 can determine that a bill (e.g., a check at a venue such as a restaurant) has been rendered to the user 120 at the end of the meal. The bill processing engine 110 can determine the bill as a potential transaction has been rendered by scanning the bill by a user device 130. In some embodiments, the user device 130 can scan a quick response code or barcode associated with the bill, a captured image of the bill, and/or the like. The bill processing engine 110 can utilize natural language processing, optical character recognition, or the like to determine that a bill has been rendered.

The bill processing engine 110 can determine and/or offer to the user 120 that the bill is to be split between the user 120 and a contact 150 of the user. The bill processing engine 110 can access a set of contacts of the user 120. In some embodiments, the bill processing engine 110 accesses the set of contacts residing on the user device 130. The bill processing engine 110 can determine a subset of contacts collocated with the user 120. The bill processing engine 110 can determine the location of the subset of contacts within proximity of the user 120 and/or the user device 130.

For purposes of clarity, the example embodiment is described as detecting a single contact 150. However, it is appreciated that multiple contacts can be detected and used for bill splitting with the user 120. In some embodiments, the bill processing engine 110 can detect a contact device 160 associated with the contact 150. For example, the bill processing engine 110 can determine location of the contact device 160 via global positioning satellite information, wireless network data, Bluetooth detection, and/or the like in relation to the user 120 and/or user device 130. In some embodiments, the bill processing engine 110 can determine the location of the contact 150 by determining a social media “check-in” for a venue that coincides with the location of the user 120 and/or user device 130.

In some embodiments, the bill processing engine 110 can determine the subset of contacts via analyzing image data to determine which contacts are collocated with the user 120. For example, the bill processing engine 110 can analyze pictures on the user device 130 and/or the contact device 160 to determine which contacts are with the user 120. For example, the user 120 may have captured a picture of the contact 150 at a venue such as a restaurant. The bill processing engine 110 can identify contacts in the picture using an image analysis technique such as computer vision techniques, artificial intelligence, a matching algorithm, and/or the like. The bill processing engine 110 can match an identified contact to a contact 150 in the user device 130.

The bill processing engine 110 determines the subset of contacts that are collocated with the user 120. The bill processing engine 110 can generate and/or send a notification to the subset of contacts. In some embodiments, the bill processing engine 110 can send a notification to the user 120. The notification can be an invitation to join a payment group. The payment group is a group of persons responsible for paying the bill (e.g., persons at a restaurant table). In some embodiments, the notification can include an opt-in, a link, a code, a one-time passcode, and/or the like that can be used and/or presented to add the contact 150 to the payment group. For example, a link in the notification can automatically add the contact 150 and/or contact device 160 to the payment group upon the contact 150 following, opening, clicking, or otherwise activating the link in the notification. The bill processing engine 110 creates the payment group from contacts of the subset of contacts that responds to the notification. In some embodiments, the user 120 can join the payment group in the same manner. In other embodiments, the user 120 is automatically added to the payment group as a default or lead person of the payment group.

The bill processing engine 110 can determine a split payment rubric for the payment group. The split payment rubric enumerates a payment responsibility for each person in the payment group. In some embodiments, the bill processing engine 110 determines the split payment rubric by analyzing image data to determine the payment responsibility of each person in the payment group. For example, the bill processing engine 110 can analyze pictures on the user device 130 and/or the contact device 160 to determine what items are to be attributed to each person in the payment group. For example, the user 120 may have captured a picture of their meal. The bill processing engine 110 can identify what the user 120 has consumed using an image analysis technique such as computer vision techniques, artificial intelligence, a matching algorithm, and/or the like. The bill processing engine 110 can match an identified item to a menu or itemized bill at the venue to determine or confirm a payment responsibility.

The bill processing engine 110 can provide the payment responsibility to each person in the payment group. The bill processing engine 110 can provide a notification of the payment responsibility to each person in the payment group via each respective device. For example, the bill's total can be $100. The bill processing engine 110 has determined that the user 120 has a payment responsibility of $60 and the contact 150 has a payment responsibility of $40. The bill processing engine 110 generates and sends a notification to the user device 130 and a second notification to the contact device 160.

The bill processing engine 110 can complete the potential transaction via payment from each device to the point of sale device 140. The point of sale device 140 can receive at least two payments to complete payment of the bill. In some embodiments, the bill processing engine 110 can generate and send a notification to the point of sale device 140 that a split payment has been sent, the payment responsibility of each person in the payment group, a payment group identification, and/or the like. The point of sale device 140 can return a receipt or acknowledgment of a completed payment to each respective payer (e.g., the user 120 and contact 150) and/or the bill processing engine 110. In some embodiments, the point of sale device 140 and/or bill processing engine 110 can provide a notification to the user 120 that the contact 150 has completed their payment to the point of sale device 140 and vice versa.

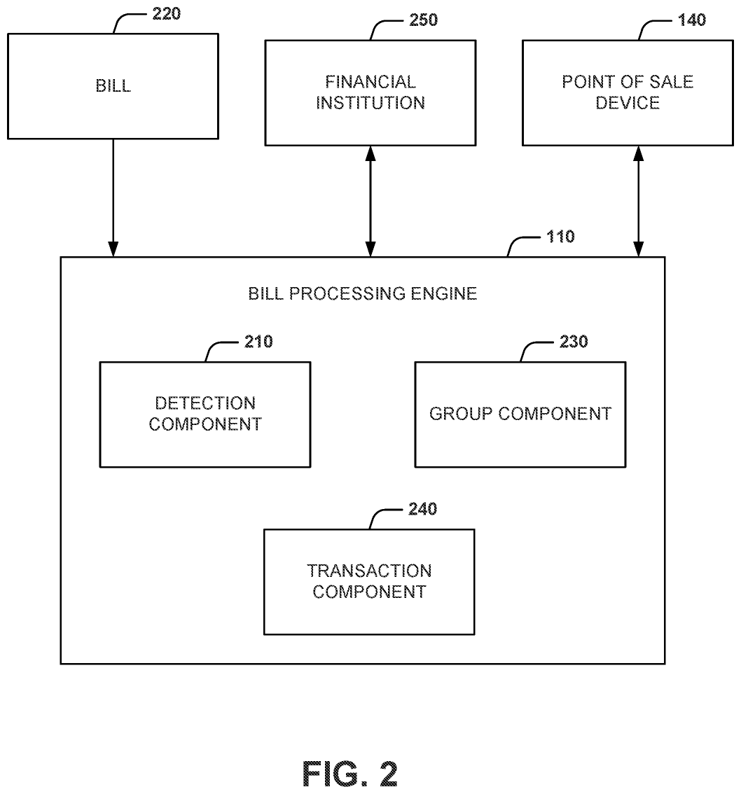

FIG. 2 illustrates a detailed component diagram of the bill processing engine 110. The bill processing engine 110 includes a detection component 210. The detection component 210 can determine whether a potential transaction is to be completed by a user 120. For example, the user 120 may be at a restaurant having a meal. The detection component 210 can determine that a bill 220 (e.g., a check) has been rendered to the user 120 at the end of the meal. The detection component 210 can determine the bill 220 as a potential transaction that has been rendered via a scan of the bill 220 by a user device 130. In some embodiments, the user device 130 can scan a quick response code or barcode associated with the bill 220, a captured image of the bill 220, and/or the like.

In some embodiments, the detection component 210 can extract bill information from the bill. The detection component 210 can utilize natural language processing, optical character recognition, and/or the like to determine information of the bill 220. The bill information can include but is not limited to venue name, venue location, total, items, item prices, number of patrons, server, a bill identifier, or the like.

The bill processing engine 110 includes a group component 230. The group component 230 can determine and/or offer to the user 120 that the bill is to be split between the user 120 and a contact 150 of the user. The group component 230 can access a set of contacts of the user 120. In some embodiments, the group component 230 accesses the set of contacts residing on the user device 130. The group component 230 can determine a subset of contacts that are collocated with the user 120. The group component 230 can determine the location of the subset of contacts that are within proximity of the user 120 and/or the user device 130.

For purposes of clarity, the example embodiment is described as detecting a contact 150. However, it is appreciated that multiple contacts can be detected and used for bill splitting with the user 120. In some embodiments, the group component 230 can detect a contact device 160 associated with the contact 150. For example, the group component 230 can determine location of the contact device 160 via global positioning satellite information, wireless network data, Bluetooth detection, and/or the like in relation to the user 120 and/or user device 130. In some embodiments, the group component 230 can determine the contact is within proximity or close to the point of sale device 140. In some embodiments, the group component 230 can determine the location of the contact 150 by determining a “check-in” for a venue that coincides with the location of the user 120 and/or user device 130.

In some embodiments, the group component 230 can determine the subset of contacts via analyzing image data to determine which contacts are collocated with the user 120. For example, the group component 230 can analyze pictures on the user device 130 and/or the contact device 160 to determine which contacts are with the user 120. For example, the user 120 may have captured a picture of the contact 150 at a venue such as a restaurant. The group component 230 can identify contacts in the picture using an image analysis technique such as computer vision, artificial intelligence, a matching algorithm, and/or the like. The group component 230 can match an identified contact to a contact in the user device 130.

In some embodiments, the group component 230 can analyze social media data of the user 120 to identify the contact 150. For example, the group component 230 can access a social networking website or application and a profile of the user 120. The group component 230 can analyze image data on the social networking website to identify contacts that are in the image. In other embodiments, the group component 230 can determine metadata, tags, and/or the like associated with the user 120 for identifying data of the contact 150. For example, a social media post or social media metadata of a post of the user 120 can state, “Having dinner with John Doe.” The group component 230 can determine that John Doe is a contact of the user 120 and is collocated with the user 120.

The group component 230 determines the subset of contacts that are collocated with the user 120. The group component 230 can generate and/or send a notification to the subset of contacts. In some embodiments, the bill processing engine 110 can send a notification to the user 120. The notification can be an invitation to join a payment group. The payment group is a group of persons that will be responsible for splitting the bill. In some embodiments, the notification can include an opt-in, a link, a code, a one-time passcode, and/or the like that can be used and/or presented to add the contact 150 to the payment group. For example, a link in the notification can automatically add the contact 150 and/or contact device 160 to the payment group upon the contact 150 following, opening, clicking, and/or the like the link in the notification. The group component 230 creates the payment group from any contacts of the subset of contacts that provides a response to the notification. In some embodiments, the user 120 can join the payment group in the same manner. In other embodiments, the user 120 is automatically added to the payment group as a default or lead person of the payment group.

The transaction component 240 can determine a split payment rubric for the payment group. The split payment rubric provides a payment responsibility for each person in the payment group. In some embodiments, the transaction component 240 determines the split payment rubric by analyzing image data to determine the payment responsibility of each person in the payment group. For example, the transaction component 240 can analyze pictures on the user device 130 and/or the contact device 160 to determine what items are to be attributed to each person in the payment group. For example, the user 120 may have captured a picture of their meal. The transaction component 240 can identify what the user 120 has consumed using an image analysis technique such as computer vision, artificial intelligence, a matching algorithm, and/or the like. The transaction component 240 can match an identified item to a menu at the venue to confirm a payment responsibility.

In some embodiments, the transaction component 240 can analyze social media data of the user 120 to identify payment responsibilities of the user 120, the contact 150, and/or the like. For example, the transaction component 240 can access a social networking website or application and a profile of the user 120, the contact 150, and/or the like. The transaction component 240 can analyze image data on the social networking website to identify payment responsibilities depicted in the image. In other embodiments, the transaction component 240 can determine metadata, tags, and/or the like associated with the user 120 for identifying data of the contact 150. In yet another embodiment, the transaction component 240 can employ natural language processing, computer vision, artificial intelligence, and/or the like to analyze social media data to determine payment responsibilities. For example, a social media post or social media metadata of the post from the user 120 or the contact 150 can have or tag the word “steak.” The transaction component 240 can attribute a payment responsibility of steak, respectively.

The transaction component 240 can provide the payment responsibility to each person in the payment group. The transaction component 240 can provide a notification of the payment responsibility to each person in the payment group via each respective device. For example, the bill's total can be $100 attributed to a steak meal and a chicken meal. The transaction component 240 has determined that the user 120 has consumed the steak, which costs $65 on the menu and therefore has a payment responsibility of $65, and the contact 150 has a payment responsibility of $35. The transaction component 240 generates and sends a notification to the user device 130 and a second notification to the contact device 160. In some embodiments, the transaction component 240 can detect a payment application, mobile wallet, and/or the like on the user device 130 and/or the contact device 160. The transaction component 240 can interface with the payment application to provide a push notification, auto-generate a payment to the point of sale device 140, and/or the like.

The transaction component 240 can complete the potential transaction via payment from each device to the point of sale device 140. The point of sale device 140 can receive at least two payments to complete payment of the bill. In some embodiments, the transaction component 240 can generate and send a notification to the point of sale device 140 that a split payment has been sent, the payment responsibility of each person in the payment group, a payment group identification, and/or the like. The point of sale device 140 or a financial institution 250 can return a receipt or acknowledgment of a completed payment to each respective payer (e.g., the user 120 and contact 150) and/or the bill processing engine 110. In some embodiments, the point of sale device 140 and/or transaction component 240 can provide a notification to the user 120 that the contact 150 has completed their payment to the point of sale device 140 and vice versa. The transaction component 240 can complete the transaction between the point of sale device 140 and the financial institution 250 associated with the user 120.

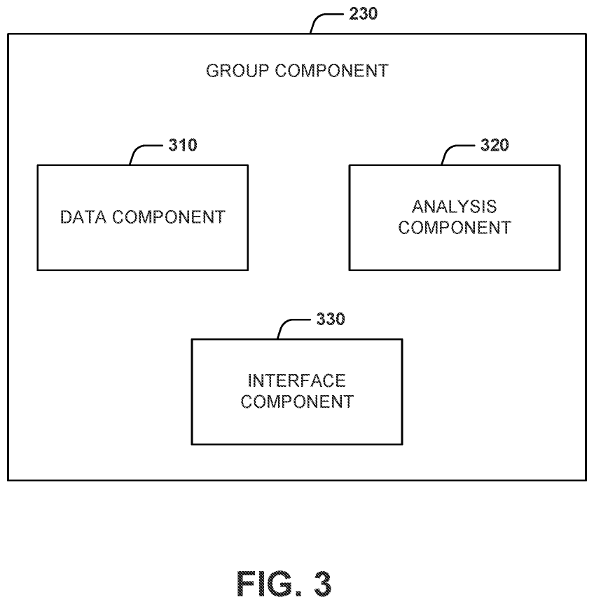

FIG. 3 illustrates a component diagram of the group component 230. The group component 230 includes a data component 310. The data component 310 can access a set of contacts of the user 120. In some embodiments, the data component 310 accesses the set of contacts residing on the user device 130. In some embodiments, the data component 310 can detect a contact device 160 associated with the contact 150. For example, the data component 310 can determine location of the contact device 160 via global positioning satellite information, wireless network connections data, Bluetooth connection detection, and/or the like in relation to the user 120 and/or user device 130. In some embodiments, the data component 310 can determine the contact is within proximity to the point of sale device 140. In some embodiments, the data component 310 can determine the location of the contact 150 by interfacing with a social media website to retrieve “check-in” data for a venue that coincides with the location of the user 120 and/or user device 130.

The group component 230 can include an analysis component 320. The analysis component 320 can determine the subset of contacts via analyzing image data to determine which contacts are collocated with the user 120. For example, the analysis component 320 can analyze pictures on the user device 130 and/or the contact device 160 to determine which contacts are with the user 120. For example, the user 120 may have captured a picture of the contact 150 at a venue such as a restaurant. The analysis component 320 can identify contacts in the picture using an image analysis technique such as computer vision, artificial intelligence, a matching algorithm, and/or the like. The analysis component 320 can match an identified contact to a contact in the user device 130. In some embodiments, the analysis component 320 can identify a relationship status between the user 120 and the contact 150 in social media data of the user 120 and/or the contact 150. The relationship status can affect determining the payment group. For example, the analysis component 320 can determine a romantic relationship between the user 120 and the contact 150 from the social media data and predict a split of the bill is unlikely. In other embodiments, the analysis component 320 can determine special occasions that may affect determining the payment group. For example, determining it is the birthday of the contact 150, the analysis component 320 can predict that a split of the bill is unlikely. In another embodiment, the analysis component 320 can analyze image data to identify the venue. For example, image data of a sign of the venue can be analyzed to determine the venue from which the bill is rendered.

In some embodiments, the analysis component 320 can determine a trend or tendency of the user 120 and/or the contact 150. The analysis component 320 can learn the tendency of the user 120 via a machine learning technique. For example, the analysis component 320 can analyze previous bills and transactions to determine if the user 120 usually splits the cost of a bottle of wine. In some embodiments, the analysis component 320 determines a prediction model via the machine learning technique. The prediction model can predict whether the user 120 is likely to split the bill when the bill is rendered. The analysis component 320 determines the prediction model based on analysis of previous transaction data or bill splitting payments. The analysis component 320 can train the prediction model via the associated data. The analysis component 320 can utilize a machine learning technique to determine trends between the user 120, the contact 150, venue, price, items, and/or the like across a history of transactions. The analysis component 320 learns from existing data to make predictions about the current bill that is rendered. The analysis component 320 builds the prediction model from the history (e.g., “training data set”) in order to make data-driven predictions or decisions expressed as outputs or assessments for the user 120 and/or the contact 150. The analysis component 320 can determine the trends and/or correlations within the historical data. In some embodiments, the analysis component 320 utilizes the machine learning technique to analyze the historical data across similar users, contacts, services, venues, and/or the like to determine a prediction model based on correlations in bill splitting data.

The group component includes an interface component 330. The interface component 330 determines the subset of contacts that are collocated with the user 120. The interface component 330 can generate and/or send a notification to the subset of contacts. In some embodiments, the interface component 330 can send a notification to the user 120. The notification can be an invitation to join a payment group. The payment group is a group of persons who will be responsible for splitting the bill. In some embodiments, the notification can include an opt-in, a link, a code, a one-time passcode, and/or the like that can be used and/or presented to add the contact 150 to the payment group. For example, a link in the notification can automatically add the contact 150 and/or contact device 160 to the payment group upon the contact 150 following, opening, clicking, and/or the like the link in the notification. The interface component 330 creates the payment group from contacts of the subset of contacts that provides a response to the notification. In some embodiments, the user 120 can join the payment group in the same manner. In other embodiments, the user 120 is automatically added to the payment group as a default or lead person of the payment group.

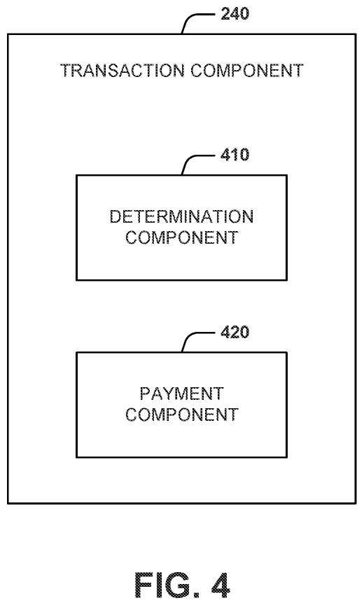

FIG. 4 illustrates a component diagram of a transaction component 240. The transaction component 240 includes a determination component 410. The determination component 410 can determine a split payment rubric for the payment group. The split payment rubric provides a payment responsibility for each person of the payment group. In some embodiments, the determination component 410 determines the split payment rubric by analyzing image data to determine the payment responsibility of each person in the payment group. For example, the determination component 410 can analyze pictures on the user device 130 and/or the contact device 160 to determine what items are to be attributed to each person in the payment group. For example, the user 120 may have captured a picture of their meal. The determination component 410 can identify what the user 120 has consumed using an image analysis technique such as computer vision, artificial intelligence, a matching algorithm, and/or the like. The determination component 410 can match an identified item to a menu at the venue to confirm a payment responsibility.

In some embodiments, the determination component 410 can determine ordering trends or tendencies of the user 120 and/or the contact 150. The determination component 410 learns the tendency of the user 120 via a machine learning technique. For example, the determination component 410 can analyze previous bills and transactions to determine what the user 120 and/or contact 150 usually orders. The determination component 410 can determine the tendencies from previous visits to the venue or more general ordering habits. The determination component 410 determines an ordering model via a machine learning technique much like the prediction model was determined above. The ordering model can predict whether the user 120 is likely to have ordered or not ordered based on a training data set of historical information about the user 120 and/or the contact 150. For example, the ordering model can learn that the user 120 tends to order shellfish dishes from the venue. The ordering model can detect shellfish on the bill and attribute the shellfish to the user 120 as the user's payment responsibility.

In some embodiments, the determination component 410 via the ordering model can determine a splitting tendency of the payment group. For example, the determination component 410 can analyze previous splits to determine whether the payment group splits the bill by a usual percentage (e.g., 50/50 split between the user 120 and the contact 150) or whether the payment group usually splits along payment responsibilities. The determination component 410 determines the likelihood of the split to factor into the splitting rubric.

The transaction component 240 includes a payment component 420. The payment component 420 can provide the payment responsibility to each person in the payment group. The payment component 420 can provide a notification of the payment responsibility to each person in the payment group via each respective device. For example, the bill's total can be $100. The determination component 410 has determined that the user 120 tends to have a payment responsibility of $60, and the contact 150 tends to have a payment responsibility of $40 at the venue. The payment component 420 generates and sends a notification to the user device 130 and a second notification to the contact device 160. In some embodiments, the payment component 420 can detect a payment application, mobile wallet, and/or the like on the user device 130 and/or the contact device 160. The payment component 420 can interface with the payment application to provide a push notification, auto-generate a payment to the point of sale device 140, and/or the like.

The payment component 420 can complete the potential transaction via payment from each device to the point of sale device 140. The point of sale device 140 can receive at least two payments to complete payment of the bill. In some embodiments, the payment component 420 can generate and send a notification to the point of sale device 140 that a split payment has been sent, the payment responsibility of each person in the payment group, a payment group identification, and/or the like. The point of sale device 140 can return a receipt or acknowledgment of a completed payment to each respective payer (e.g., the user 120 and contact 150) and/or the payment component 420. In some embodiments, the point of sale device 140 and/or payment component 420 can provide a notification to the user 120 that the contact 150 has completed their payment to the point of sale device 140 and vice versa.

In some embodiments, the payment component 420 can generate a virtual card number for completing payment of the bill. The virtual card number can be a one-time virtual card number for completing the payment. Each person in the payment group can provide their payment responsibility to the virtual card number to fund the virtual card number to complete the transaction. The point of sale device 140 can process the virtual card number as a single transaction to complete the bill.

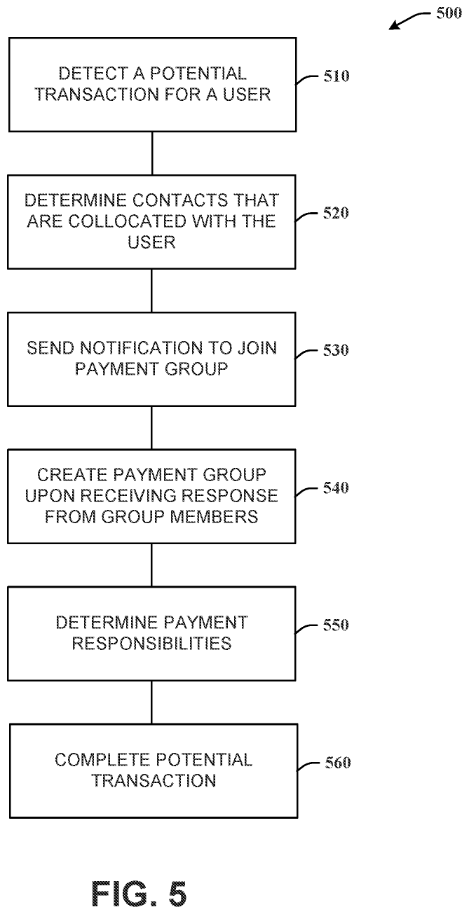

With reference to FIG. 5, example method 500 is depicted for automated payment splitting. While, for purposes of simplicity of explanation, the one or more methodologies herein, e.g., in the form of a flow chart, are shown and described as a series of acts, it is to be understood and appreciated that the disclosed subject matter is not limited by the order of acts, as some acts may occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement the method described hereinafter. It is also appreciated that the method 500 is described in conjunction with a specific example for explanation purposes.

FIG. 5 illustrates a method 500 for automated payment splitting. At 510, a potential transaction involving a user can be detected. The detecting can include detecting a bill has been incurred for goods and/or services. At 520, collocated contacts to the user are determined. For example, the bill processing engine 110 can detect contacts via global positioning satellite data, social media data, and/or the like to detect location and/or proximity to the user 120. At 530, a notification can be sent to join a payment group. The bill processing engine 110 can send a push notification, text message, and/or the like to contact devices and/or the user. The notification can include an automated link or one-time passcode to join the payment group.

At 540, the payment group can be created. The bill processing engine 110 creates the payment group from contacts that respond to the notification. In some embodiments, the bill processing engine 110 generates the payment group from collocated contacts and removes contacts that opt out of the payment group. At 550, payment responsibilities can be determined. The bill processing engine 110 can determine payment responsibilities for each person in the payment group. For example, the bill processing engine 110 can detect which items are to be attributed to each person via image analysis, social media data, consumption tendencies, and/or the like. At 560, the potential transaction can be completed. In some embodiments, the user device 130 and/or the contact device 160 can interface with the bill processing engine 110 and/or the point of sale device 140 to complete payment of each person's payment responsibilities.

As used herein, the terms “component” and “system,” as well as various forms thereof (e.g., components, systems, sub-systems), are intended to refer to a computer-related entity, either hardware, a combination of hardware and software, software, or software in execution. For example, a component can be, but is not limited to being, a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

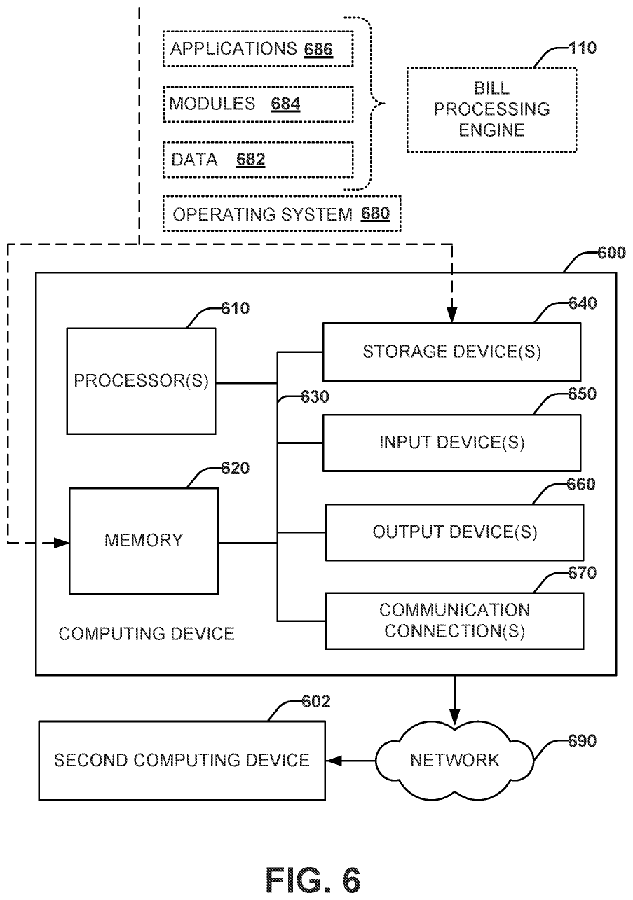

To provide a context for the disclosed subject matter, FIG. 6, as well as the following discussion, are intended to provide a brief, general description of a suitable environment in which various aspects of the disclosed subject matter can be implemented. The suitable environment, however, is solely an example and is not intended to suggest any limitation as to the scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, and data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules can be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer-executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 610 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that is accessible to the computing device 600 and includes volatile and nonvolatile media and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 620 and storage device(s) 640 are examples of computer-readable storage media. Depending on the configuration and type of computing device, the memory 620 can be volatile (e.g., random access memory (RAM)), nonvolatile (e.g., read only memory (ROM), flash memory . . . ), or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/nonvolatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the bill processing engine 110 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of a processor is more powerful, as it embeds hardware and software therein that enable particular functionality with minimal or no reliance on external hardware and software. For example, the bill processing engine 110 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED)), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of bill processing engine 110, and the second computing device 602 can be a user device that communicates and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that, when executed by the processor, cause the processor to:
determine a potential transaction to be completed by a user;
identify a subset of contacts that are collocated with the user;
automatically send a notification to the user and the subset of contacts to join a payment group;
create the payment group based on receiving a response from at least one contact of the subset of contacts and the user;
analyze social media image data of the user or the at least one contact;
identify a payment responsibility based on a result of analysis of the social media image data, wherein identification of the payment responsibility includes:
identify items that appear in the social media image data based on the result of the analysis of the social media image data;
match the items that are identified in the social media image data to items of an itemized bill of the potential transaction; and
associate items that are matched to a person in the payment group based on the social media image data and the match; and
determine a split payment rubric for the payment group, wherein the split payment rubric provides the payment responsibility for each person of the payment group; and
complete the potential transaction with two or more payments from the payment group according to the split payment rubric.

2. The system of claim 1, wherein determine the subset of contacts includes instructions that cause the processor to analyze social media image data of contacts to determine contacts that are collocated with the user.

3. The system of claim 1, wherein the instructions further cause the processor to apply a computer vision technique to the social media image data to identify the user and one or more contacts in the social media image data to determine the user and the one or more contacts are currently collocated.

4. The system of claim 1, wherein the instructions further cause the processor to extract metadata associated with the social media image data to identify one or more contacts that are collocated with the user.

5. The system of claim 1, wherein the notification includes a link and wherein the link adds a contact in the subset of contacts to the payment group when opened.

6. The system of claim 1, wherein the subset of contacts is determined from a set of contacts of the user that is associated with a user device.

7. The system of claim 1, wherein determine the split payment rubric comprises instructions that cause the processor to analyze social media metadata to determine payment responsibility of each person in the payment group.

8. The system of claim 7, wherein the instructions further cause the processor to confirm the match of the items to the itemized bill of the potential transaction to the person in the payment group based on analysis of the social media metadata.

9. The system of claim 1, wherein determine the split payment rubric comprises instructions that cause the processor to determine payment responsibility of each person in the payment group by way of tendencies learned about each person in the payment group.

10. A method, comprising:
executing, on a processor, instructions that cause the processor to perform operations associated with bill splitting, the operations comprising:
determining a potential transaction to be completed by a user;
analyzing social media image data of the user to determine a subset of contacts that are collocated with the user;
automatically sending a request to the user and the subset of contacts to join a payment group;
creating the payment group based on receiving a response to the request from at least one contact, wherein the payment group includes the at least one contact and the user; and
completing the potential transaction with two or more payments from the payment group.

11. The method of claim 10, wherein the operations further comprise determining the subset of contacts from a set of contacts of the user that is associated with a user device.

12. The method of claim 10, wherein the operations further comprise applying a computer vision technique to the social media image data to identify the user and one or more contacts in the social media image data to determine the user and the one or more contacts are currently collocated.

13. The method of claim 10, wherein the operations further comprise determining metadata associated with the social media image data to identify one or more contacts that are collocated with the user.

14. The method of claim 10, wherein sending the request further comprises providing a link that adds a contact in the subset of contacts to the payment group when activated.

15. The method of claim 10, wherein the operations further comprise predicting a split payment rubric for the payment group, wherein the split payment rubric provides a payment responsibility for each person of the payment group.

16. The method of claim 15, wherein determining the split payment rubric further comprises:
analyzing social media image data to determine the payment responsibility for each person in the payment group, wherein determining the payment responsibility includes:
identifying items that appear in the social media image data based on analysis of social media image data;
matching the items that are identified in the social media image data to items of an itemized bill of the potential transaction; and
associating items that are matched to a person in the payment group based on the social media image data and the matching.

17. The method of claim 15, wherein the operations further comprise:
determining a relationship between the user and the at least one contact based on social media data; and
predicting the split payment rubric based on the relationship between the user and the at least one contact.

18. The method of claim 15, wherein determining the split payment rubric comprises determining a payment responsibility of each person in the payment group via tendencies that are learned of each person in the payment group.

19. A computer-implemented method, comprising:
determining a user and a bill;
determining a subset of contacts that are collocated with the user, wherein the subset of contacts is determined from a set of contacts of the user, wherein determining the subset includes:
analyzing image data of a set of contacts to determine contacts that are collocated with the user;
sending a notification to join a payment group to the subset of contacts; and
receiving a response from at least one contact of the subset of contacts;
creating the payment group based on receiving the response from the at least one contact of the subset of contacts;
determining a split payment rubric for the payment group, wherein determining the split payment rubric includes:
analyzing the image data or consumption tendencies of each person in the payment group to determine a payment responsibility of each person in the payment group; and
completing a payment of the bill via a split payment amongst the payment group according to the split payment rubric.

20. The method of claim 19, wherein completing the payment comprises:
generating a one-time virtual card number to complete the payment of the bill;
funding the one-time virtual card number with a split payment amongst the payment group; and
completing payment of the bill via the one-time virtual card number.
